(19) United States
(12) Patent Application Publication
(10) Pub. No.: US 2025/0211085 A1
(43) Pub. Date: Jun. 26, 2025

(54) LIGHT LOAD EFFICIENCY BOOST FOR SWITCHED CAPACITOR POWER CONVERTERS

(71) Applicant: Intel Corporation, Santa Clara, CA (US)

(72) Inventors: Huanhuan Zhang, Ashland, MA (US); Arvind Raghavan, Lexington, MA (US); Christopher Schaef, San Diego, CA (US); Keng Chen, Acton, MA (US); Sivaraman Masilamani, Marietta, GA (US); Yura Kocharyan, Fremont, CA (US)

(21) Appl. No.: 18/394,927

(22) Filed: Dec. 22, 2023

(51) Int. Cl. H02M 1/00; H02M 3/07

(52) U.S. Cl. CPC H02M 1/0032; H02M 1/0048; H02M 3/07

(57) ABSTRACT

Embodiments herein relate to a switched capacitor power converter which reduces the leakage current through a power switch when the power switch is turned off. In one aspect, a first charge pump provides a voltage Vcc_cp which is higher than a power supply voltage Vcc, and a second charge pump provides a voltage Vss_cp which is lower than a ground voltage Vss. Transistors are used to couple the first charge pump to the control gate of a p-type power switch and to couple the second charge pump to the control gate of an n-type power switch. In another example implementation, the voltage of the power switch is pulled up or down using a bootstrap capacitor.

### FIELD

The present application generally relates to the field of power converters.

### BACKGROUND

Computing devices often rely on power converters to obtain power. A power converter is an electrical circuit which accepts a direct current (DC) input and generates a DC output of a different voltage, usually achieved by high frequency switching of inductive and/or capacitive elements. For example, a power converter can convert the main supply voltage of a computing device, such as 12-48 V, down to lower voltages, such as about 1 V. The lower voltages can be used by various components in the computing device, such as a Universal Serial Bus (USB) interface, memory such as dynamic random access memory (DRAM) and processing resources such as a central processing unit (CPU). However, it is challenging to supply power in an efficient manner.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 depicts an example switched capacitor voltage regulator 100 with leakage reduction, in accordance with various embodiments.

FIG. 2 depicts example waveforms for the power switch circuit 111 of FIG. 1, in accordance with various embodiments.

FIG. 3 depicts example waveforms for the power switch circuit 131 of FIG. 1, in accordance with various embodiments.

FIG. 4 depicts an example implementation of the power switches and a capacitor in the switched capacitor voltage regulator 100 of FIG. 1, in accordance with various embodiments.

FIG. 5 depicts example waveforms for the circuit 400 of FIG. 4, in accordance with various embodiments.

FIG. 6 depicts example plots of efficiency versus operating frequency for the switched capacitor voltage regulator 100 of FIG. 1 with the leakage reduction active (plot 600) or inactive (plot 610), in accordance with various embodiments.

FIG. 7 depicts an example switched capacitor voltage regulator 700 with leakage reduction of a p-type power switch 710 using a bootstrap capacitor 701, in accordance with various embodiments.

FIG. 8 depicts example waveforms for the voltage regulator 700 of FIG. 7, in accordance with various embodiments.

FIG. 9 depicts an example switched capacitor voltage regulator 900 with leakage reduction of an n-type power switch 910 using a bootstrap capacitor 901, in accordance with various embodiments.

FIG. 10 depicts example waveforms for the voltage regulator 900 of FIG. 9, in accordance with various embodiments.

FIG. 11 depicts an example flowchart for a process for operating a switched capacitor voltage regulator, consistent with FIG. 1-5, in accordance with various embodiments.

FIG. 12 illustrates an example of components that may be present in a computing system 1250 for implementing the techniques (e.g., operations, processes, methods, and methodologies) described herein.

### DETAILED DESCRIPTION

As mentioned at the outset, various challenges are presented in supplying power from a power converter in an efficient manner.

As cutting-edge digital processes continue to scale to smaller dimensions, transistors are more and more susceptible to leakage. For example, for the gate-all-around (GAA) process, device leakage is prominent in a switched capacitor power converter because of a significant number of power switches. GAA results in a transistor structure where the gate can come into contact with the channel on all sides. One example is a RibbonFET (field effect transistor) which uses a stack of semiconductor sheets to form the channel. GAA is a successor to technologies such as FinFET, where the gate covers the channel region on three sides.

A switched capacitor power converter works by selecting one input power switch at a time to input charge from a voltage rail to a capacitor, and by selecting one output power switch at a time to output charge from the capacitor. The leakage can involve charge leaking through the unselected power switches.

This leakage can degrade the power delivery efficiency in the switched capacitor voltage converters at a light load, in particular. For example, for a continuous capacitive voltage regulator (C2VR), there could be several power switches per operating cell that turn on at different times. For each switch, the ON time only occupies a small percentage of an operative cycle, which makes the C2VR architecture more susceptible to leakage than other converter types.

In particular, the C2VR efficiency at different clock frequencies is proportional to load current under typical/70 C and fast/125 C (1 GHz is maximum clock frequency) conditions. C2VR efficiency degrades noticeably in a leaky corner at light load. While at a heavy load, C2VR efficiency also suffers from incompleteness of charge transfer constrained by the resistance-capacitance (RC) time constant being a technology parameter. With the C2VR being restricted at two load sides, there is minimal freedom to improve efficiency by optimizing power switch sizes. One approach is to reduce the static leakage by modulating the power switch size. This can involve activating a varying number of power switches based on the load size. However, a further challenge is to address a dynamically operating power delivery system which includes features such as reduction of the maximum operating frequency (fmax) based on the load size. For example, the C2VR can operate with a slower clock and a smaller power switch size at light load conditions.

The solutions provided herein address the above and other disadvantages. In one aspect, a solution is provided for reducing leakage in a dynamically operating power delivery system such as a high-speed switched capacitor power converter.

In an example implementation, the solution can pull up a control gate voltage of a p-type power switch to a level Vcc_cp which is higher than the power supply voltage Vcc. The solution can also pull down a control gate voltage of an n-type power switch to a negative voltage Vss_cp which is lower than a ground voltage Vss. Vcc_cp and Vss_cp can be provided by power rails of a pull up charge pump and a pull down charge pump, respectively. When a power switch is dynamically switched off, the pull up charge pump only has to provide the switching power for the difference between Vcc and Vcc_cp, and the pull down charge pump only has to provide the switching power for the difference between Vss and Vss_cp. The switching power of the charge pumps is therefore minimized.

In one approach, each power switch is driven by a respective driver. For a p-type power switch, a first transistor is coupled between the power supply and the power supply terminal of the driver, a second transistor is coupled between the pull up charge pump and the control gate of the power switch, and a third transistor is coupled between a ground terminal of the driver and a ground node. When the p-type power switch is to be switched off, the driver provides Vcc to the control gate of the power switch. Additionally, after a delay, the first transistor is turned off and the second transistor is turned on. The turn off of the first transistor disables the driver. The turn on of the second transistor couple a Vcc_cp to the control gate.

For an n-type power switch, a first transistor is coupled between the power supply and the power supply terminal of the driver, a second transistor is coupled between the pull down charge pump and the control gate of the power switch, and a third transistor is coupled between a ground terminal of the driver and a ground node. When the n-type power switch is to be switched off, the driver provides Vss to the control gate of the power switch. Additionally, after a delay, the first transistor is turned off and the second transistor is turned on. The turn off of the first transistor disables the driver. The turn on of the second transistor couples Vss_cp to the control gate.

In another example implementation, the voltage of the power switch is pulled up or down using a bootstrap capacitor.

The solutions provide a number of advantages including boosting efficiency at normal and light loads in a normal, non-idle power state. Another advantage involves freeing up one side of the C2VR efficiency vs. load curve. This provides the design freedom to move the operation region to the left of the efficiency curve.

These and other features will be further apparent in view of the following discussion.

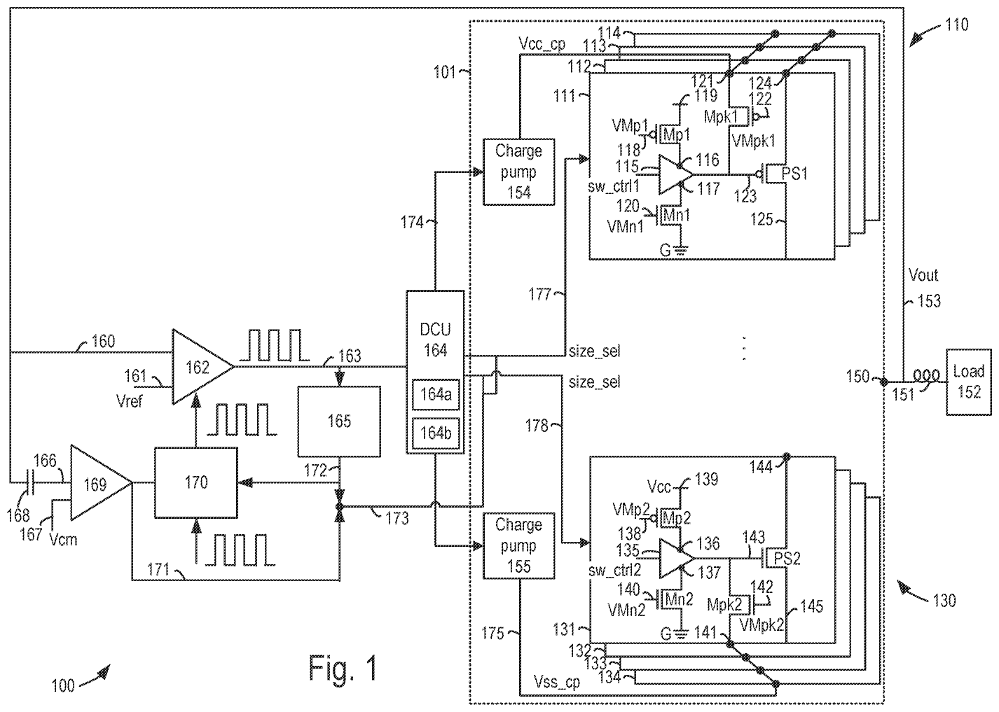

FIG. 1 depicts an example switched capacitor voltage regulator 100 with leakage reduction, in accordance with various embodiments. The voltage regulator can include multiple sets of p-type and n-type power switch circuits. The p-type power switch circuits can input charge to one or more capacitors of the voltage regulator while the n-type power switch circuits can output charge from the one or more capacitors to provide an output of the voltage regulator. Additionally, each power switch circuit can include multiple switches that can operate in parallel, where one or more of the switches are selected based on the load in a process referred to as switch modulation.

For simplicity, the figure depicts one set of p-type power switch circuits 110 which includes individual power switch circuits 111, 112, 113 and 114. Each individual power switch circuit includes a power switch such as a p-type transistor. One possible example is a p-type Metal Oxide Semiconductor Field-effect Transistor (MOSFET). The p-type transistors in a set may be the same size or of different sizes.

The figure also depicts one set of n-type power switch circuits 130 which includes individual power switch circuits 131, 132, 133 and 134. Each individual power switch circuit includes a power switch such as an n-type transistor. One possible example is an n-type MOSFET. The sets of power switch circuits are arranged in a power circuit 101 which provides an output voltage Vout and a current at an output node 150 to a load 152 via an inductor 151. The n-type transistors in a set may be the same size or of different sizes.

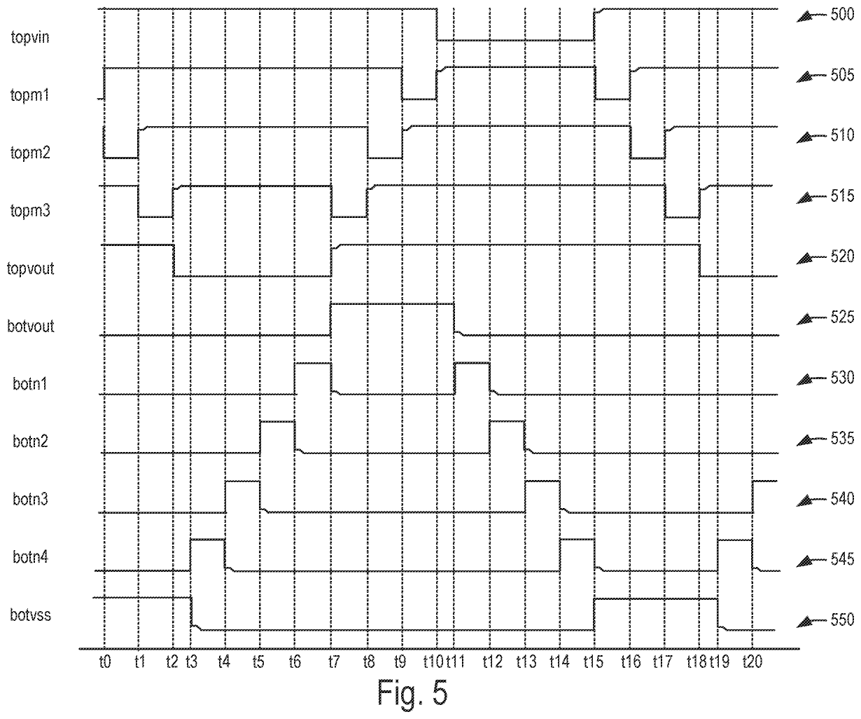

The power switch circuit 111 includes a driver 115 having a power supply terminal 116 and a ground terminal 117. The driver receives a control signal sw_ctrl1. The control signal can cause the driver to output Vcc from the power supply node 119 via the first transistor Mp1 or to output Vss from the ground node G via the transistor Mn1, for instance. Mp1 has a control gate 118 to receive a control signal VMp1. Mn1 has a control gate 120 to receive a control signal VMn1. The transistor symbols herein includes a circle on the control gate to denote a p-type MOSFET or no circle to denote an n-type MOSFET. The output of the driver 115 is the control gate 123 of the power switch PS1. When PS1 is turned on (conductive), e.g., when its control gate voltage is low, such as 0 or a negative voltage, it passes a voltage and current from a voltage rail 124 at a source of the transistor to an output path 125 at a drain of the transistor. The output paths of the p-type power switches can be coupled to an input terminal of a capacitor such as depicted in FIG. 5.

The power switch circuit 131 includes a driver 135 having a power supply terminal 136 and a ground terminal 137. The driver receives a control signal sw_ctrl2. The control signal can cause the driver to output Vcc from the power supply node 139 via the first transistor Mp2 or to output Vss from the ground node G via the transistor Mn2. Mp2 has a control gate 138 to receive a control signal VMp2. Mn2 has a control gate 140 to receive a control signal VMn2. The output of the driver 135 is the control gate 143 of the power switch PS2. When PS2 is turned on (conductive), e.g., when its control gate voltage is high, such as Vcc, it passes a voltage and current from a node 144 or voltage rail at a drain of the transistor to an output path 145 at a source of the transistor. The output paths of the n-type transistors can be coupled to an output terminal of a capacitor such as depicted in FIG. 5.

The drivers 115 and 135 can include one or more buffers in series, for example.

In one approach, each power switch circuit 111-114 in the set of power switch circuits 110 is coupled to a common voltage rail 124. Other sets of power switch circuits can also be coupled to a common respective voltage rail, where the different voltage rails are at different levels including Vcc, Vss and intermediate levels between Vcc and Vss. Similarly, each power switch circuit 131-134 in the set of power switch circuits 130 can be coupled to a common voltage rail 144. Other sets of power switch circuits can also be coupled to a common respective voltage rail, where the different voltage rails are at different levels including Vcc, Vss and intermediate levels between Vcc and Vss. See also FIG. 5.

Each set of p-type power switch circuits can include a pull up transistor coupled between the control gate of the power switch and a first or pull up charge pump 154 which provides the pull up voltage Vcc_cp. For example, in the power switch circuit 111, a pull up transistor Mpk1 is coupled between the control gate 123 and the charge pump 154. When Mpk1 is turned on, Vcc_cp is coupled to the control gate of PS1 via a node 121 to provide it in a strongly non-conductive state to reduce leakage when the switch is not selected to pass charge to the capacitor. Mpk1 has a control gate 122 to receive a control signal VMpk1.

One or both of the charge pumps 154 and 155 can be used to reduce leakage through the power gates PS1 and PS2, respectively. The voltages from the charge pumps 154 and 155 can also be used to drive control gate voltages in the sets of power switch circuits 110 and 130, respectively.

Similarly, in the power switch circuit 131, a pull down transistor Mpk2 is coupled between the control gate 143 and the charge pump 155. When Mpk2 is turned on, Vss_cp is coupled to the control gate of PS2 via a node 141 to provide it in a more strongly non-conductive state to reduce leakage when the switch is not selected to receive charge from the capacitor and pass it to the output node 150. Mpk2 has a control gate 142 to receive a control signal VMpk2.

The power circuit 101 can be under the control of a control circuit such as a digital control unit (DCU) 164, which can provide control signals such as sw_ctrl1, VMp1, VMn1 and VMpk1 to the set of power switch circuits 110, and control signals such as sw_ctrl2, VMp2, VMn2 and VMpk2 to the set of power switch circuits 130. The DCU can also provide a size select control signal (size_sel) to the set of power switch circuits 110 via a path 177, and a size select control signal to the set of power switch circuits 130 via a path 178. The size select signal can be used to turn on (activate) a desired number of power switch circuits in a set of power switch circuits based on the load. The DCU can also control the charge pumps 154 and 155 via signals on paths 174 and 175, respectively.

The DCU can be include a processor 164a which executes instructions stored in a memory device 164b to provide the functions described herein.

A voltage Vout of the output node 150 is fed back via a feedback path 153. A comparator 162 compares Vout on a path 160 to a reference voltage Vref on a path 161 and provides a signal on a path 163 to the DCU indicating whether an adjustment is needed in terms of the number of active switches, for example. A comparator 169 compares Vout on a path 166 after a capacitor 168 to a common mode voltage Vcm on a path 167 and provides a corresponding output to a clock divider 170. The output is also provided on a path 171. The clock divider can divide a system clock to a lower frequency when the system is in a light load condition. A further input to the clock divider is a sensed current on a path 172 from a current sensor 165. The sensed current can be used to inform the size selection as indicated by the path 173.

The transistors Mn, Mp and Mpk can thus be added to each power switch circuit. Additionally, two charge pump power rails are generated where Vcc_cp is, e.g., 100 mV above Vcc and Vss_cp is, e.g., 100 mV below Vss. With Vss=0 V, for example, Vss_cp is a negative voltage. When a p-type power switch is dynamically switched off, the control gate is pulled up to the Vcc rail before Mpk1 turns on to drive it to Vcc_cp. When an n-type power switch is dynamically switched off, the control gate is pulled down to the Vss rail before Mpk2 turns on to drive it to Vss_cp.

In this way, the Vcc_cp and Vss_cp rails only provide the switching power for delta voltage of 100 mV, for example, at a maximum of power switch control frequency ˜30 MHz even when C2VR operates at 1 GHz. In the meantime, when switch size modulation is used, for the disabled portion of the p-type power switches, VMp1 can be set to Vcc_cp or other turn off voltage and VMn1 can be set to Vss_cp or other turn on voltage. For the enabled portion of the p-type power switches, Mpk1, which can be a smaller transistor than Mp1, is enabled and the control gate of the power FET is parked at Vcc_cp.

For the disabled portion of the n-type power switches, VMp2 can be set to Vcc_cp or other turn off voltage and VMn2 can be set to Vss_cp or other turn on voltage. For the enabled portion of the n-type power switches, Mpk2, which can be a smaller transistor than Mp2, is enabled and the control gate of the power FET is parked at Vss_cp.

In advanced FinFET or Ribbon FET process nodes, for instance, there are significant channel leakages when Vgs is already equal to 0 V. For large power switches, the leakage is considerable and it starts to degrade efficiency at especially light loads during an active mode. For C2VR, the leakage effect is even more noticeable considering the large number of switches.

Take C2VR as example in active mode. It can adjust its maximum frequency and power switch sizes. When the current sensor 165 senses the load current as light load, the DCU can cause the maximum frequency (fmax) and switch size to gear down to a lower value until an under voltage protection signal is triggered, after which fmax and switch size are switched back to a maximum setting.

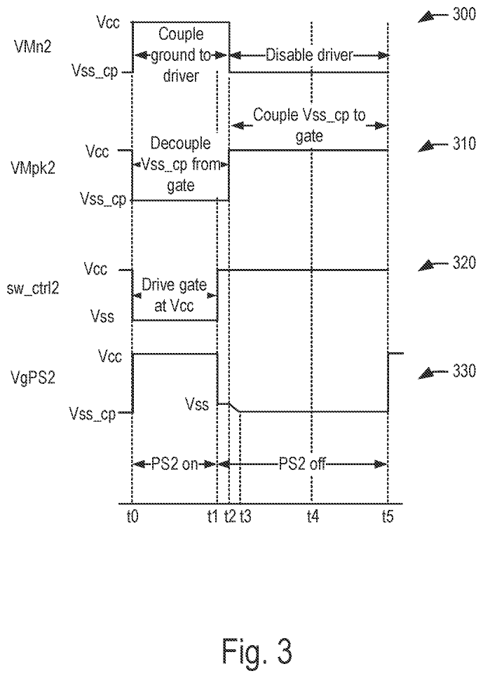

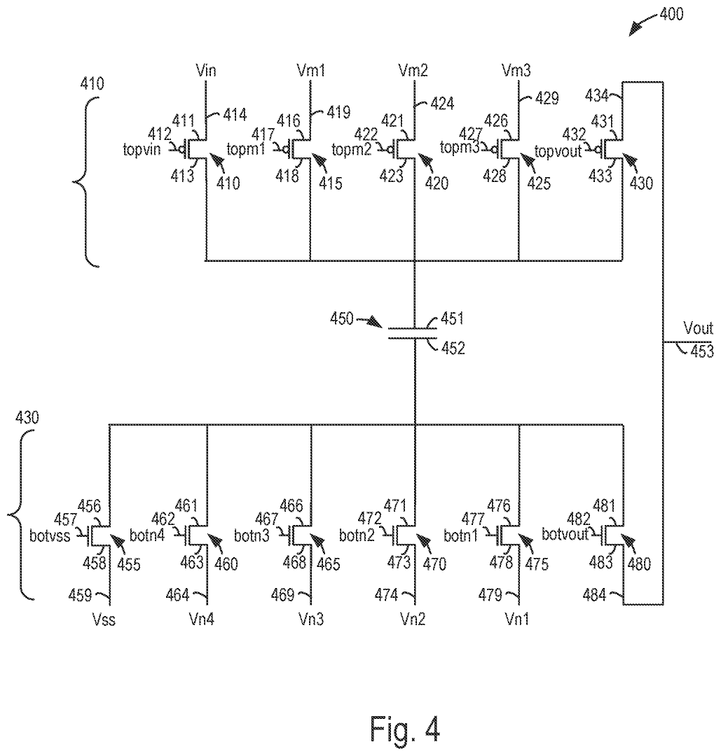

In an example implementation, Mp, Mn and Mpk are added to the driver circuit for leakage reduction. While the power FET is active, the added devices are in standby if the dynamic feature is disabled. Once enabled, the dynamic feature is achieved by disabling the driver and enabling the park device (Mpk) right after Vgate is settled to the OFF voltage. In this way, a large power draw is eliminated from the charge pump, which results in area savings for the charge pump. When the power train switch is modulated, part of the switch is disabled but they disabled switches are still susceptible to leakages. A main contributor is the power FET leakage following the leakage from the last stage of the driver. By parking Mp, Mn, Mpk and the control gate of the power FET at corresponding Vcc_cp or Vss_cp values, the leakage in the disabled static state is effectively reduced. Example control sequences are shown in FIGS. 3 and 4 for the power switch circuits 111 and 131, respectively.

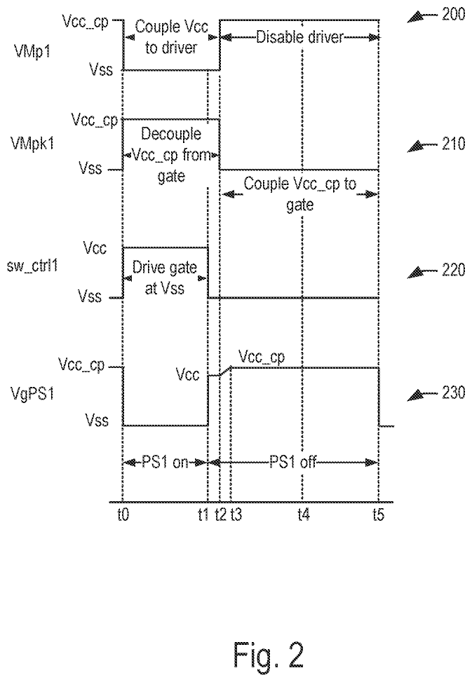

FIG. 2 depicts example waveforms for the power switch circuit 111 of FIG. 1, in accordance with various embodiments. The waveforms extend over a time period represents by times points t0-t5. The waveform 200 represents the control signal VMp1 which controls the p-type transistor Mp1. At t0-t2, when VMp1 is low (Vss), Mp1 is turned on so that Vcc_cp from the power supply node is coupled to the power supply terminal of the driver. This voltage enables the driver to pass Vcc_cp to the control gate of the power switch PS1. At t2-t5, VMp1 is high (Vcc_cp), so that Mp1 is turned off and the driver is disabled.

The waveform 210 represents the control signal VMpk1 which controls the p-type transistor Mpk1. At t0-t2, when VMpk1 is high, Mpk1 is turned off so that Vcc_cp from the charge pump 154 is decoupled from the control gate of PS1. At t2-t5, Mpk1 is turned on with VMpk1=Vss, so that the control gate of PS1 is pulled up from Vcc to Vcc_cp (at t2-t3).

The waveform 220 represents the control signal sw_ctrl1. At t0-t1, when sw_ctrl is at a first, high level (Vcc), the gate of PS1 is driven at Vss so that PS1 is turned on. At t1-t2, when sw_ctrl1 is at a second, low level (Vss), the control gate of PS1 is driven at Vcc.

The waveform 230 represents the control gate voltage VgPS1 of PS1. At t0-t1, VgPS1 is driven at Vss so that it is turned on. At t1-t2, VgPS1 is driven at Vcc since the driver is still enabled and outputs Vcc. At t2-t3, VgPS1 increases from Vcc to Vcc_cp as the charge pump voltage is provided. There is ramp up time as Mpk1 is smaller than Mp1 in this example. PS1 is more strongly off at t2-t5 than at t1-t2 since it has a larger gate bias.

VMn1 can remain at Vcc during the time span depicted.

Note that it is possible to turn off the leakage reduction feature of the p-type switches by setting VMp1 low, VMn1 and VMpk1 high and controlling sw_ctrl1 as indicated. VgPS1 will be similar to what is shown but will have a high level of Vcc instead of Vcc_cp.

Another feature involves setting switch size=low and parking PS1 during switch size modulation. In this case, VMp1 and VgPS1 are high and VMn1, VMpk1 and sw_ctrl1 are low.

Vcc and Vcc_cp are examples of first and second turn off levels, respectively, of a control gate voltage of a p-type power switch.

FIG. 3 depicts example waveforms for the power switch circuit 131 of FIG. 1, in accordance with various embodiments. The waveforms extend over a time period represents by times points t0-t5. The waveform 300 represents the control signal VMn2 which controls the n-type transistor Mn2. At t0-t2, when VMn2 is high (Vcc), Mn2 is turned on so that Vss_cp from the ground node is coupled to the ground terminal of the driver. VMp2 can remain at Vss during the time span depicted to enable the driver. At t2-t5, VMn2 is low (Vss_cp), so that Mp2 is turned off and the driver is disabled.

The waveform 310 represents the control signal VMpk2 which controls the n-type transistor Mpk2. At t0-t2, when VMpk2 is low (Vss_cp), Mpk2 is turned off so that Vss_cp from the charge pump 155 is decoupled from the control gate of PS2. At t2-t5, Mpk2 is turned on (VMpk2=Vcc) so that the control gate of PS1 (VgPS2) is pulled down from Vss to Vss_cp (at t2-t3) (plot 330).

The waveform 320 represents the control signal sw_ctrl2. At t0-t1, when sw_ctrl is at a first, low level (Vss), the gate of PS2 is driven at Vcc so that PS2 is turned on. At t1-t2, when sw_ctrl1 is at a second, high level (Vcc), VgPS2 is driven at Vss.

The waveform 330 represents the control gate voltage VgPS2 of PS2. At t0-t1, VgPS2 is driven at Vcc so that it is turned on. At t1-t2, VgPS2 is driven at Vss since the driver is still enabled and outputs Vss. At t2-t3, VgPS2 decreases from Vss to Vss_cp as the charge pump voltage is provided. There is ramp down time as Mpk2 is smaller than Mp2 in this example. PS2 is more strongly off at t2-t5 than at t1-t2 since it has a larger gate bias.

Note that it is possible to turn off the leakage reduction feature of the n-type switches by setting VMp2 low, VMn2 high, and VMpk2 low and controlling sw_ctrl2 as indicated. VgPS2 will be similar to what is shown but will have a low level of Vss instead of Vss_cp.

Another feature involves setting switch size=low and parking PS2 during switch size modulation. In this case, VMp2, VMpk2 and sw_ctrl2 are high and VMn2 and VgPS2 are low.

Vss and Vss_cp are examples of first and second turn off levels, respectively, of a control gate voltage of an n-type power switch.

FIG. 4 depicts an example implementation of the power switches and a capacitor in the switched capacitor voltage regulator 100 of FIG. 1, in accordance with various embodiments. The example circuit 400 includes a set of input power switches 410, a set of output power switches 430 and a capacitor 450 between the two sets of switches. The set of input power switches 410 can represent six instances of the power switch circuit 111 of FIG. 1, and the set of output power switches 430 can represent six instances of the power switch circuit 131, for example. The additional power switches used for switch modulation are not depicted.

While one capacitor is depicted as a charge transfer component, one or more capacitors can be used. The input power switches include a number of switches which can transfer charge to an input terminal or first side 451 of the capacitor 450. Each of these switches is coupled at their source or drain to a respective voltage rail and at the opposing side, at their drain or source, respectively, to the first side of the capacitor. Each of these switches is coupled between a respective voltage rail and the capacitor. In this example, the input power switches are p-type MOSFETs so that their source is coupled to a respective voltage rail and their drain is coupled to the first side of the capacitor. Each input power switch receives a respective control gate voltage to turn the switch on or off to couple or decouple, respectively, the respective voltage rail to the first side of the capacitor.

The input power switch 410 is coupled to a power rail 414 at Vin. The input power switches 415, 420 and 425 are coupled to power rails 419, 424 and 429, respectively, at Vm1, Vm2 and Vm3, respectively. The input power switch 430 is coupled to an output path 434.

The power switch 410 has a source 411, a drain 413 and a control gate 412 which receives a voltage toptvin. The power switch 415 has a source 416, a drain 418 and a control gate 417 which receives a voltage topm1. The power switch 420 has a source 421, a drain 423 and a control gate 422 which receives a voltage topm2. The power switch 425 has a source 426, a drain 428 and a control gate 427 which receives a voltage topm3.

The power switch 430 is coupled between the top side of the capacitor and the output node 453. The power switch 430 has a source 431, a drain 433 and a control gate 432 which receives a voltage topvout.

The output power switches include a number of switches which can transfer charge from an output terminal or second side 452 of the capacitor 450 to the output node 453 at a voltage Vout. In this example, the output power switches are n-type MOSFETs so that their source is coupled to a respective voltage rail and their drain is coupled to the second side of the capacitor. Each output power switch receives a respective control gate voltage to turn the switch on or off to couple or decouple, respectively, the respective voltage rail to the second side of the capacitor.

The output power switches 455, 460, 465, 470 and 475 are coupled to power rails 459, 464, 469, 474 and 479, respectively, at Vss, Vn4, Vn3, Vn2 and Vn1, respectively. The output power switch 480 is coupled to an output path 484.

The power switch 455 has a source 458, a drain 456 and a control gate 457 which receives a voltage botvss. The power switch 460 has a source 463, a drain 461 and a control gate 462 which receives a voltage botn4. The power switch 465 has a source 468, a drain 466 and a control gate 467 which receives a voltage botn3. The power switch 470 has a source 473, a drain 471 and a control gate 472 which receives a voltage botn2. The power switch 475 has a source 478, a drain 476 and a control gate 477 which receives a voltage botn1.

The power switch 480 is coupled between the second side of the capacitor and the output node 453. The power switch 480 has a source 483, a drain 481 and a control gate 482 which receives a voltage botvout.

The power rails can be at different levels, as mentioned. For example, on the input side, Vin can be the highest power rail, e.g., at Vcc, and Vm1-Vm3 can be progressively lower voltages. On the output side, Vn1 can be the highest power rail, e.g., at Vcc, and Vn1-Vss can be progressively lower voltages.

FIG. 5 depicts example waveforms for the circuit 400 of FIG. 4, in accordance with various embodiments. The waveforms depicts the control gate voltages of the power switches in FIG. 4. The control gate voltages include topvin (plot 500), topm1 (plot 505), topm2 (plot 510), top m3 (plot 515), topvout (plot 520), botvout (plot 525), botn1 (plot 530), botn2 (plot 535), botn3 (plot 540), botn4 (plot 545) and botvss (plot 550).

In an example process, one input power switch at a time is turned on and one output power switch at a time is turned on. Also, one input power switch and one output power switch may be on concurrently.

Consistent with FIG. 2, the plots 500, 505, 510, 515 and 520 include a transition of the control gate voltage from Vcc to Vcc_cp when the respective p-type transistor is turned off and the pull up charge pump is coupled in to reduce leakage current. These waveforms range in magnitude from Vss to Vcc_cp.

Similarly, consistent with FIG. 3, the plots 525, 530, 535, 540, 545 and 550 include a transition of the control gate voltage from Vss to Vss_cp when the respective n-type transistor is turned off and the pull down charge pump is coupled to reduce leakage current. These waveforms range in magnitude from Vss_cp to Vcc.

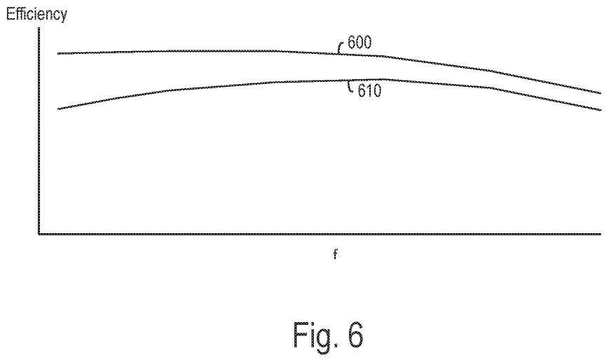

FIG. 6 depicts example plots of efficiency versus operating frequency for the switched capacitor voltage regulator 100 of FIG. 1 with the leakage reduction active (plot 600) or inactive (plot 610), in accordance with various embodiments. As mentioned, the leakage reduction solution provided herein significantly increases efficiency, especially at lighter loads (lower values of f).

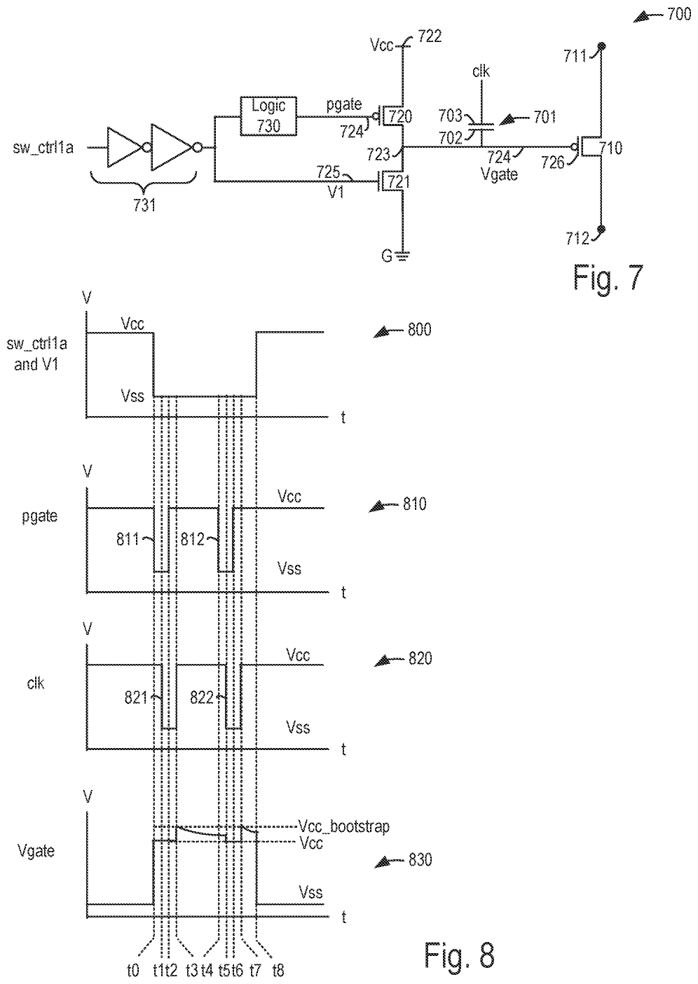

FIG. 7 depicts an example switched capacitor voltage regulator 700 with leakage reduction of a p-type power switch 710 using a bootstrap capacitor 701, in accordance with various embodiments. This is another example solution for dynamic leakage reduction. The voltage regulator 700 includes a first, p-type transistor 720 coupled in series with a second, n-type transistor 721. A source of the p-type transistor is coupled to a power supply node 722 at Vcc and a drain of the p-type transistor is coupled to an output node 723. A drain of the n-type transistor is coupled to the node 723 and a source of the n-type transistor 721 is coupled to a ground node G. The output node 723 is coupled to a path 724 which in turn is coupled to the control gate 726 of the p-type power switch 710. The capacitor 701 is coupled at one side 702 to the path 724 and at another side 703 to a path which receives a clock signal clk. A source of the p-type power switch 710 is coupled to a power rail 711 to receive a respective voltage and a drain of the p-type power switch 710 is coupled to a capacitor of the switched capacitor voltage regulator 700 via a node 712.

The p-type transistor 720 receives a control gate voltage pgate on a path 724 from a logic circuit 730. The logic circuit is coupled to a driver 731 which includes two buffers in series in this example. An input to the driver is the control signal sw_ctrl1a. An output of the driver is a voltage V1. The n-type transistor 721 receives V1 as a control gate voltage on a path 725.

The operation of the logic circuit can be synchronized with clk as depicted in the waveforms of FIG. 8. In an example implementation, the logic circuit sets pgate low to intermittently turn on the p-type transistor 720 to pass Vcc to the node 723 and the path 724 as Vgate. The turn on of the p-type transistor is synchronized with a transition in clk. In the transition, clk decreases and then increases. The increase in clk causes an increase in the voltage across the capacitor so that a voltage on the path 724 increases. This results in a pull up of the control gate voltage of the p-type power switch 710 from Vcc to Vcc_bootstrap.

The bootstrap capacitor has a voltage which can be roughly 10% of the power FET parasitic gate capacitance, resulting in Vcc_bootstrap of around 110% of Vcc. This implementation does not use the charge pump power rails. All of the extra power needed is from Vcc or Vss.

FIG. 8 depicts example waveforms for the voltage regulator 700 of FIG. 7, in accordance with various embodiments. The waveforms depict sw_ctrl1a and V1 (plot 800), pgate (plot 810), clk (plot 820) and Vgate (plot 830). A range of time points t0-t8 is also depicted. Before t0, sw_ctrl1a and V1 are at a high level such as Vcc. At t0-t8, sw_ctrl1a and V1 are at a lower level such as Vss. After t8, sw_ctrl1a and V1 return to the high level.

Before t0, pgate is at a high level so that the p-type transistor 720 is off, clk is also at a high level and Vgate is at a low level such as Vss. At t0-t2, pgate decreases to Vss and then increases back to Vcc. The p-type transistor 720 is on in this period. At t2-t4, pgate remains at Vcc so that the p-type transistor 720 is off in the period. At t4-t6, pgate decreases again to Vss and then increases back to Vcc. The p-type transistor 720 is again on in this period. After t6, pgate returns to Vcc so that the p-type transistor 720 is off. The decreases and increase in pgate are represented by pulses 811 and 812.

Before t0, at t3-t5 and after t7, clk is at a high level. At t1-t3 and t5-t7, clk decreases to Vss and then increases back to Vcc in pulses 821 and 822. The pulse of clk overlaps with, and is delayed relative to, each pulse of pgate. That is, a start of the decrease of clk at t1 is after a start of the decrease of pgate at to, and a start of the increase of elk at t3 is after a start of the increase of pgate at t2. Similarly, a start of the decrease of clk at t5 is after a start of the decrease of pgate at t4, and a start of the increase of clk at t7 is after a start of the increase of pgate at t6. When clk decreases, the transistor 720 is on so that the path 724 is held at Vcc. However, when clk increases, the transistor is off so that the voltage of the path 724 is floating. The increase in clk at the side 703 of the capacitor 701 therefore increases a voltage at the side 702 and at the path 724.

This effect is evident in Vgate (plot 830). Before t0, the transistor 720 is off and the transistor 721 in on so that the path 724 is at Vss. When pgate turns on at t0-t2, Vgate increases to Vcc. At t2-t3, pgate turns off the transistor 720 so that Vgate floats at Vcc. When clk increases at t3, Vgate is boosted higher above Vcc to a level referred to as Vcc_bootstrap. This boost is transient and attenuates over time, from t2-t4. At t4-t6, pgate again turns on to drive the path 724 at Vcc. The process for boosting Vgate can then repeated. It is repeated once here but generally can be performed one or more times after a single transition of sw_ctrl1a, e.g., from high to low.

At t6-t7, pgate turns off the transistor 720 so that Vgate floats at Vcc. When clk increases at t7, Vgate is again boosted to Vcc_bootstrap. This boost is transient and attenuates over time, from t6-t8. At t8, sw_ctrl1a goes high to signal the end of the current cycle of boosting. The cycle can be repeated periodically.

The time period from t0 to t2 is an example of a first time period, and the time period from t1 to t3 is an example of a second time period. The decrease and increase of the clock is in the second time period which starts after a start of the first time period and ends after an end of the first time period.

By boosting Vgate when the power switch 710 is turned off, the leakage of the power switch is reduced.

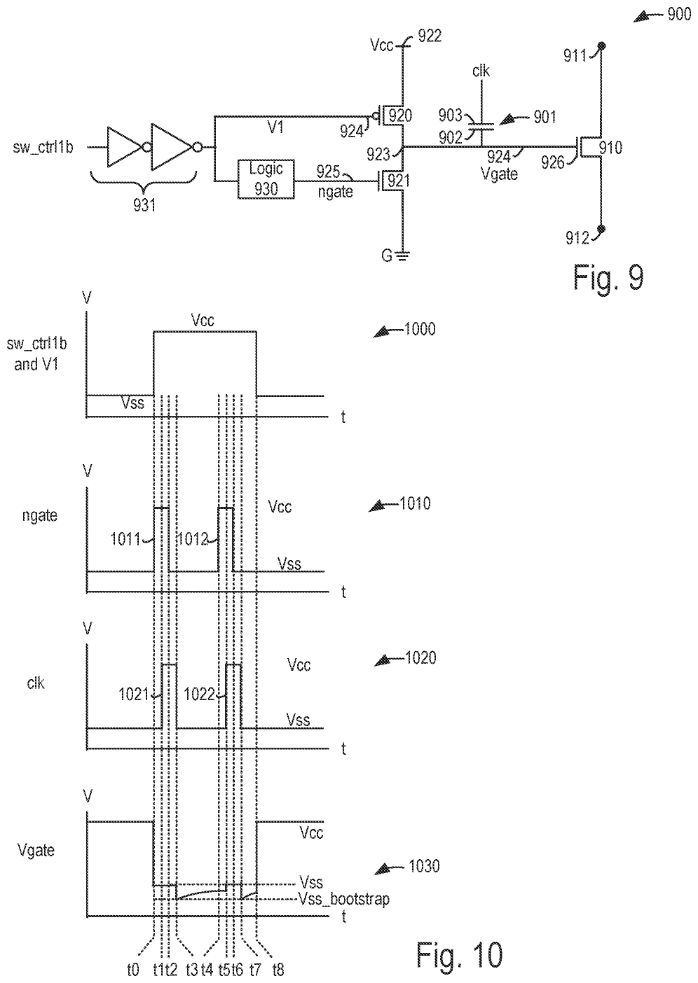

FIG. 9 depicts an example switched capacitor voltage regulator 900 with leakage reduction of an n-type power switch 910 using a bootstrap capacitor 901, in accordance with various embodiments.

The voltage regulator 900 includes a first, p-type transistor 920 coupled in series with a second, n-type transistor 921. A source of the p-type transistor is coupled to a power supply node 922 at Vcc and a drain of the p-type transistor is coupled to an output node 923. A drain of the n-type transistor is coupled to the node 923 and a source of the n-type transistor is coupled to a ground node G. The output node 923 is coupled to a path 924 which in turn is coupled to the control gate 926 of the n-type power switch 910. The capacitor 901 is coupled at one side 902 to the path 924 and at another side 903 to a path which receives a clock signal clk. A drain of the n-type power switch 710 is coupled to the capacitor via a node 911 and a source of the n-type power switch 710 is coupled to an output path of the switched capacitor voltage regulator 900 via a node 912.

The n-type transistor 921 receives a control gate voltage ngate on a path 925 from a logic circuit 930. The logic circuit is coupled to a driver 931 which includes two buffers in series in this example. An input to the driver is the control signal sw_ctrl1b. An output of the driver is a voltage V1. The p-type transistor 920 receives V1 as a control gate voltage on a path 924.

The operation of the logic circuit can be synchronized with clk as depicted in the waveforms of FIG. 10. In an example implementation, the logic circuit sets ngate high to intermittently turn on the n-type transistor 921 to pass Vss to the node 923 and the path 924 as Vgate. The turn on of the n-type transistor is synchronized with a transition in clk. In the transition, clk increases and then decreases. The decrease in clk causes a decrease in the voltage across the capacitor so that a voltage on the path 924 decreases. This results in a pull down of the control gate voltage of the n-type power switch 910 from Vss to Vss_bootstrap.

The bootstrap capacitor has a voltage which can be roughly ˜10% of the power FET parasitic gate capacitance, resulting in a negative Vss_bootstrap with a magnitude of around 10% of Vcc.

FIG. 10 depicts example waveforms for the voltage regulator 900 of FIG. 9, in accordance with various embodiments. The waveforms depict sw_ctrl1b and V1 (plot 1000), ngate (plot 1010), clk (plot 1020) and Vgate (plot 1030). A range of time points t0-t8 is also depicted. Before t0, sw_ctrl1b and V1 are at a low level such as Vss. At t0-t8, sw_ctrl1b and V1 are at a higher level such as Vcc. After t8, sw_ctrl1b and V1 return to the low level.

Before t0, ngate is at a low level so that the n-type transistor 921 is off, clk is also at a low level and Vgate is at a high level such as Vcc. At t0-t2, ngate increases to Vcc and then decreases back to Vss. The n-type transistor 921 is on in this period. At t2-t4, ngate remains at Vcc so that the n-type transistor 921 is off in the period. At t4-t6, ngate increases again to Vcc and then decreases back to Vss. The n-type transistor 921 is again on in this period. After t6, ngate returns to Vss so that the n-type transistor 921 is off. The increases and decrease in ngate are represented by pulses 1011 and 1012.

Before t0, at t3-t5 and after t7, clk is at a low level. At t1-t3 and t5-t7, clk increases to Vcc and then decreases back to Vss in pulses 1021 and 1022. The pulse of clk overlaps with, and is delayed relative to, each pulse of ngate. That is, a start of the increase of clk at t1 is after a start of the increase of ngate at to, and a start of the decrease of clk at t3 is after a start of the decrease of ngate at t2. Similarly, a start of the increase of clk at t5 is after a start of the increase of ngate at t4, and a start of the decrease of clk at t7 is after a start of the decrease of ngate at t6. When clk increases, the transistor 921 is on so that the path 924 is held at Vss. However, when clk decreases, the transistor is off so that the voltage of the path 924 is floating. The decrease in clk at the side 903 of the capacitor 901 therefore causes a decrease in a voltage at the side 902 and at the path 924.

This effect is evident in Vgate (plot 1030). Before t0, the transistor 921 is off and the transistor 921 in on so that the path 924 is at Vss. When ngate turns on at t0-t2, Vgate decreases to Vss. At t2-t3, ngate turns off the transistor 921 so that Vgate floats at Vss. When clk decreases at t3, Vgate is boosted lower below Vss to a level referred to as Vss_bootstrap. This boost is transient and attenuates over time, from t2-t4. At t4-t6, ngate again turns on the transistor 921 to drive the path 924 at Vss. The process for boosting Vgate can then repeated. It is repeated once here but generally can be performed one or more times after a single transition of sw_ctrl1b, e.g., from low to high.

At t6-t7, ngate turns off the transistor 921 so that Vgate floats at Vcc. When clk decreases at t7, Vgate is again boosted to Vss_bootstrap. This boost is transient and attenuates over time, from t6-t8. At t8, sw_ctrl1b goes low to signal the end of the current cycle of boosting. The cycle can be repeated periodically.

The time period from t0 to t2 is an example of a first time period, and the time period from t1 to t3 is an example of a second time period. The increase and decrease of the clock is in the second time period which starts after a start of the first time period and ends after an end of the first time period.

By boosting Vgate when the power switch 910 is turned off, the leakage of the power switch is reduced.

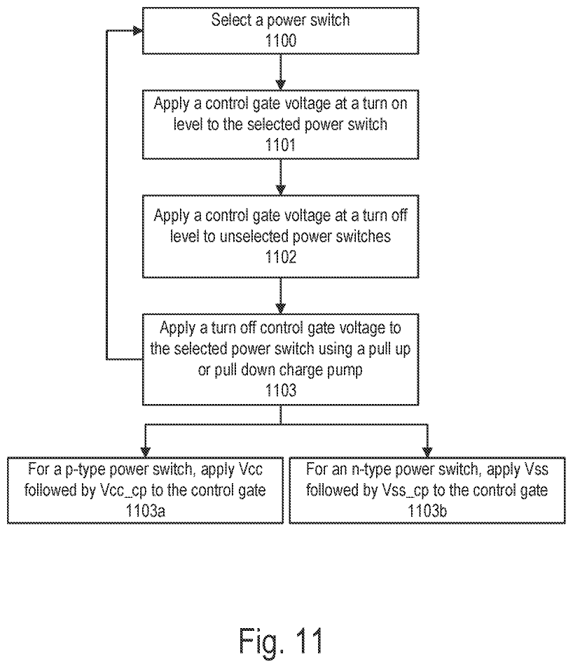

FIG. 11 depicts an example flowchart for a process for operating a switched capacitor voltage regulator, consistent with FIG. 1-5, in accordance with various embodiments. Block 1100 includes selecting a power switch among a plurality of power switches. Block 1101 includes applying a control gate voltage at a turn on level to the selected power switch. Block 1102 includes applying a control gate voltage at a turn off level to unselected power switches. Block 1103 includes applying a turn off control gate voltage to the selected power switch using a pull up or pull down charge pump. This can involve, e.g., block 1103a for a p-type power switch or block 1103b for an n-type power switch.

Block 1103a includes, for a p-type power switch, applying Vcc (a first voltage level) followed by Vcc_cp (a second voltage level) to the control gate. Block 1103b includes, for an n-type power switch, applying Vss (a first voltage level) followed by Vss_cp (a second voltage level) to the control gate. The process then continues with selection of a new power switch.

In another aspect, when load current is low, e.g., below a lower threshold, a portion of the switches in a power switch circuit can be turned off and parked in an anti-leakage mode, e.g., with Vcc_cp applied to the control gate of a p-type power switch and Vss_cp applied to the control gate of an n-type power switch. This portion of the switches is one or more switches, and fewer than all switches, in a power switch circuit. And, when the load current is high, e.g., above an upper threshold, all of the switches in a power switch circuit can be turned on. This can be triggered by an under voltage protection (UVP) circuit or by a pulse-counting circuit, for example.

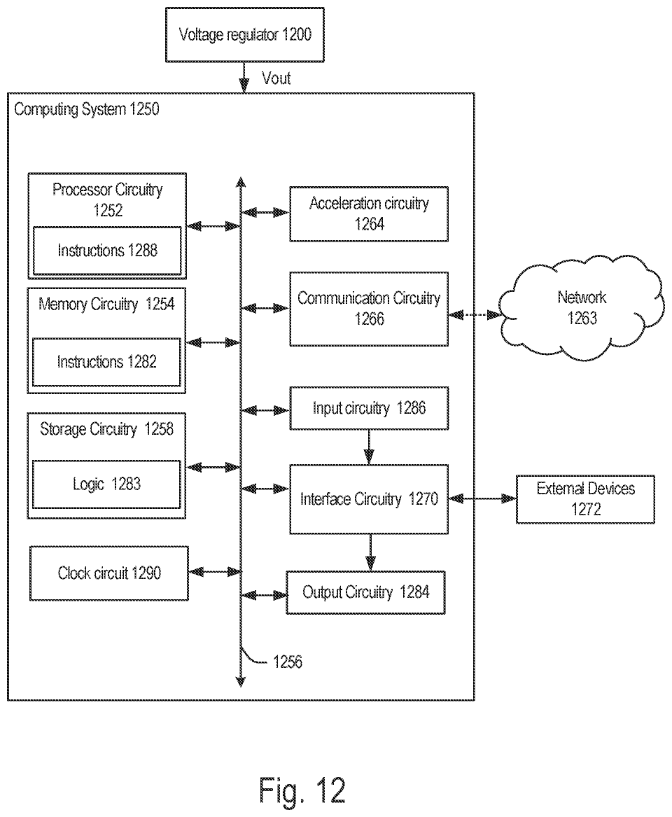

FIG. 12 illustrates an example of components that may be present in a computing system 1250 for implementing the techniques (e.g., operations, processes, methods, and methodologies) described herein. The voltage regulator 1200 may represent one or more of the switched capacitor power converters provided herein.

The computing system 1250 may include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 1250, or as components otherwise incorporated within a chassis of a larger system. For one embodiment, at least one processor 1252 may be packaged together with computational logic 1282 and configured to practice aspects of various example embodiments described herein to form a System in Package (SiP) or a System on Chip (SoC).

The voltage regulator 1200 may provide a voltage Vout to one or more of the components of the computing system 1250. The memory circuitry 1254 may store instructions and the processor circuitry 1252 may execute the instructions to perform the functions described herein.

The system 1250 includes processor circuitry in the form of one or more processors 1252. The processor circuitry 1252 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 1252 may include one or more hardware accelerators (e.g., same or similar to acceleration circuitry 1264), which may be microprocessors, programmable processing devices (e.g., FPGA, ASIC, etc.), or the like. The one or more accelerators may include, for example, computer vision and/or deep learning accelerators. In some implementations, the processor circuitry 1252 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein

The processor circuitry 1252 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low-voltage processor, an embedded processor, or any other known processing elements, or any suitable combination thereof. The processors (or cores) 1252 may be coupled with or may include memory/storage and may be configured to execute instructions stored in the memory/storage to enable various applications or operating systems to run on the platform 1250. The processors (or cores) 1752 is configured to operate application software to provide a specific service to a user of the platform 1750. In some embodiments, the processor(s) 1752 may be a special-purpose processor(s)/controller(s) configured (or configurable) to operate according to the various embodiments herein.

As examples, the processor(s) 1252 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 1252 may be a part of a system on a chip (SoC), System-in-Package (SiP), a multi-chip package (MCP), and/or the like, in which the processor(s) 1252 and other components are formed into a single integrated circuit, or a single package, such as SoC boards from Intel® Corporation. Other examples of the processor(s) 1252 are mentioned elsewhere in the present disclosure.

The system 1250 may include or be coupled to acceleration circuitry 1264, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 1264 may comprise logic blocks or logic fabric and other interconnected resources that may be programmed (configured) to perform various functions, such as the procedures, methods, functions, etc. of the various embodiments discussed herein. In such implementations, the acceleration circuitry 1264 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 1252 and/or acceleration circuitry 1264 may include hardware elements specifically tailored for machine learning and/or artificial intelligence (AI) functionality. In these implementations, the processor circuitry 1252 and/or acceleration circuitry 1764 may be, or may include, an AI engine chip that can run many different kinds of AI instruction sets once loaded with the appropriate weightings and training code. Additionally or alternatively, the processor circuitry 1252 and/or acceleration circuitry 1264 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPS™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 1252 and/or acceleration circuitry 1764 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin provided by Huawei®, and/or the like. In some hardware-based implementations, individual subsystems of system 1250 may be operated by the respective AI accelerating co-processor(s), AI GPUs, TPUs, or hardware accelerators (e.g., FPGAS, ASICs, DSPs, SoCs, etc.), etc., that are configured with appropriate logic blocks, bit stream(s), etc. to perform their respective functions.

The system 1250 also includes system memory 1254. Any number of memory devices may be used to provide for a given amount of system memory. As examples, the memory 1254 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 1254 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 1254 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 1258 provides persistent storage of information such as data, applications, operating systems and so forth. In an example, the storage 1258 may be implemented via a solid-state disk drive (SSDD) and/or high-speed electrically erasable memory (commonly referred to as “flash memory”). Other devices that may be used for the storage 1258 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 1254 and/or storage circuitry 1258 may also incorporate three-dimensional (3D) cross-point (XPOINT) memories from Intel® and Micron®.

The memory circuitry 1254 and/or storage circuitry 1258 is/are configured to store computational logic 1283 in the form of software, firmware, microcode, or hardware-level instructions to implement the techniques described herein. The computational logic 1283 may be employed to store working copies and/or permanent copies of programming instructions, or data to create the programming instructions, for the operation of various components of system 1250 (e.g., drivers, libraries, application programming interfaces (APIs), etc.), an operating system of system 1250, one or more applications, and/or for carrying out the embodiments discussed herein. The computational logic 1283 may be stored or loaded into memory circuitry 1254 as instructions 1282, or data to create the instructions 1282, which are then accessed for execution by the processor circuitry 1252 to carry out the functions described herein. The processor circuitry 1252 and/or the acceleration circuitry 1264 accesses the memory circuitry 1254 and/or the storage circuitry 1258 over the interconnect (IX) 1256. The instructions 1282 direct the processor circuitry 1252 to perform a specific sequence or flow of actions, for example, as described with respect to flowchart(s) and block diagram(s) of operations and functionality depicted previously. The various elements may be implemented by assembler instructions supported by processor circuitry 1252 or high-level languages that may be compiled into instructions 1288, or data to create the instructions 1288, to be executed by the processor circuitry 1252. The permanent copy of the programming instructions may be placed into persistent storage devices of storage circuitry 1258 in the factory or in the field through, for example, a distribution medium (not shown), through a communication interface (e.g., from a distribution server (not shown)), over-the-air (OTA), or any combination thereof.

The IX 1256 couples the processor 1252 to communication circuitry 1266 for communications with other devices, such as a remote server (not shown) and the like. The communication circuitry 1266 is a hardware element, or collection of hardware elements, used to communicate over one or more networks 1263 and/or with other devices. In one example, communication circuitry 1266 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 1266 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 1256 also couples the processor 1252 to interface circuitry 1270 that is used to connect system 1250 with one or more external devices 1272. The external devices 1272 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 1250, which are referred to as input circuitry 1286 and output circuitry 1284. The input circuitry 1286 and output circuitry 1284 include one or more user interfaces designed to enable user interaction with the platform 1250 and/or peripheral component interfaces designed to enable peripheral component interaction with the platform 1250. Input circuitry 1286 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 1284 may be included to show information or otherwise convey information, such as sensor readings, actuator position(s), or other like information. Data and/or graphics may be displayed on one or more user interface components of the output circuitry 1284. Output circuitry 1284 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 1250. The output circuitry 1284 may also include speakers and/or other audio emitting devices, printer(s), and/or the like. Additionally or alternatively, sensor(s) may be used as the input circuitry 1284 (e.g., an image capture device, motion capture device, or the like) and one or more actuators may be used as the output device circuitry 1284 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 1250 may communicate over the IX 1256. The IX 1256 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 1256 may be a proprietary bus, for example, used in a SoC based system.

The number, capability, and/or capacity of the elements of system 1250 may vary, depending on whether computing system 1250 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 1250 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible, non-transitory machine readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

Some non-limiting examples of various embodiments are presented below.

Example 1 includes an apparatus, comprising: a power switch among a plurality of power switches which are coupled to a capacitor; a driver coupled to a control gate of the power switch, wherein the driver has a power supply terminal and a ground terminal; a first transistor (Mp1) coupled between the power supply terminal and a node (Vcc); a charge pump (Vcc_cp); and a second transistor (Mpk1) coupled between the control gate of the power switch and the charge pump.

Example 2 includes the apparatus of Example 1, wherein the power switch is a first power switch, the charge pump is a first charge pump, and the apparatus further comprises: a second power switch coupled to the capacitor; a second charge pump; and a third transistor coupled between a control gate of the second power switch and the second charge pump.

Example 3 includes the apparatus of Example 1 or 2, wherein: the capacitor is a charge transfer component in a switched capacitor voltage converter; and the power switch is a p-type input power switch of the switched capacitor voltage converter or the power switch is an n-type output power switch of the switched capacitor voltage converter.

Example 4 includes the apparatus of any one of Examples 1-3, wherein: the capacitor is a charge transfer component in a switched capacitor voltage converter; each power switch of the plurality of power switches is coupled between a respective voltage rail and the capacitor; and each respective voltage rail is to provide a voltage at a different level.

Example 5 includes the apparatus of any one of Examples 1-4, further comprising a third transistor coupled between the ground terminal and a ground node, wherein the third transistor is to turn on to couple the ground terminal to the ground node.

Example 6 includes the apparatus of any one of Examples 1-5, wherein: the driver is to apply a turn off voltage to the control gate of the power switch while another power switch of the plurality of power switches is turned on; and during the applying of the turn off voltage to the control gate of the power switch, the first transistor is to receive a control gate voltage to turn off and block the power supply terminal from the node and the second transistor is to receive a control gate voltage to turn on to couple the control gate of the power switch to the charge pump.

Example 7 includes the apparatus of any one of Examples 1-6, wherein a turn off of the first transistor and a turn on of the second transistor are started after a start of the driver applying a turn off voltage to the power switch.

Example 8 includes the apparatus of any one of Examples 1-7, wherein the node is a ground node and when the second transistor is turned on, the charge pump is to decrease a voltage of the control gate of the power switch from a voltage of the ground node to a voltage which is output by the charge pump.

Example 9 includes the apparatus of any one of Examples 1-7, wherein the node is a power supply node and when the second transistor is turned on, the charge pump is to increase a voltage of the control gate of the power switch from a voltage of the power supply node to a voltage which is output by the charge pump.

Example 10 includes the apparatus of Example 9, wherein the voltage which is output by the charge pump provides a greater leakage protection for the power switch compared to the voltage of the power supply node.

Example 11 includes the apparatus of any one of Examples 1-10, further comprising a switched capacitor voltage converter which includes the plurality of power switches, the capacitor, the driver, the first transistor, the charge pump and the second transistor, wherein the switched capacitor voltage converter is provided in at least one of an integrated circuit, a System on Chip, a System in Package or a computing device.

Example 12 includes an apparatus, comprising: a first transistor in series with a second transistor, wherein the first transistor is coupled to a power supply node; a power switch having a control gate coupled to a node between the first transistor and the second transistor; a bootstrap capacitor coupled to the control gate of the power switch, wherein the bootstrap capacitor is to receive a clock signal; a logic circuit coupled to a control gate of the first transistor; and a driver coupled to the logic circuit and to a control gate of the second transistor.

Example 13 includes the apparatus of Example 12, wherein: the power switch comprises a p-type transistor; in response to a transition in an output of the driver, the logic circuit is to turn on the first transistor to increase a voltage of the control gate of the power switch to a voltage of the power supply node; and the clock is to decrease and then increase, to increase the voltage of the control gate of the power switch higher than the voltage of the power supply node based on a voltage across the bootstrap capacitor.

Example 14 includes the apparatus of Example 13, wherein: the logic circuit is to turn on the first transistor for a first time period; and the decrease and increase of the clock is in a second time period which starts after a start of the first time period and ends after an end of the first time period.

Example 15 includes the apparatus of Example 13 or 14, wherein the turn on of the first transistor and the decrease and then increase of the clock occur multiple times after a single transition of the output of the driver.

Example 16 includes an apparatus, comprising: a memory to store instructions; and a control circuit to execute the instructions to: apply a control gate voltage at a turn on level to one selected power switch at a time among a first plurality of power switches to couple a respective voltage rail of the selected power switch to a capacitor in a switched capacitor voltage converter, wherein each power switch of the first plurality of power switches is coupled between the respective voltage rail and to the capacitor; and apply control gates voltages at a first turn off level and then at a second turn off level to unselected power switches of the first plurality of power switches during the applying of the control gate voltage at the turn on level to the one selected power switch, wherein when the unselected power switches comprise n-type transistors, the first turn off level is less than the second turn off level, and when the unselected power switches comprise p-type transistors, the first turn off level is greater than the second turn off level.

Example 17 includes the apparatus of Example 16, wherein: the first plurality of power switches are in a power switch circuit; when a load current of the switched capacitor voltage converter is below a lower threshold, the control circuit is to execute the instructions to turn off, and park in an anti-leakage mode, a portion of all power switches in the power switch circuit; and when the load current is above an upper threshold, the control circuit is to execute the instructions to turn on all of the power switches of the power switch circuit.

Example 18 includes the apparatus of Example 16 or 17, wherein: each power switch of the first plurality of power switches comprises a respective driver coupled to a control gate of the power switch; the respective driver comprises a power supply terminal coupled to a power supply node; the control gate of the power switch is coupled to a respective charge pump; and the first turn off level is based on a level of the power supply node and the second turn off level is based on a level of the respective charge pump, which is greater than the level of the power supply node.

Example 19 includes the apparatus of Example 16 or 17, wherein: each power switch of the first plurality of power switches comprises a respective driver coupled to a control gate of the power switch; the respective driver comprises a ground terminal coupled to a ground node; the control gate of the power switch is coupled to a respective charge pump; and the first turn off level is based on a level of the ground node and the second turn off level is based on a level of the respective charge pump, which is less than the level of the ground node.

Example 20 includes the apparatus of any one of Examples 16-19, wherein the first plurality of power switches are coupled to a first side of the capacitor and the control circuit is to execute the instructions to: apply a control gate voltage at a turn on level to one selected power switch at a time among a second plurality of power switches to couple a respective voltage rail of the selected power switch among the second plurality of power switches to a second side of the capacitor, wherein each power switch of the second plurality of power switches is coupled between an output node and the second side of the capacitor.

Example 21 includes a method, comprising: controlling a first plurality of power switches which are coupled to a capacitor, to transfer charge to the capacitor; and controlling a second first plurality of power switches which are coupled to the capacitor, to output charge from the capacitor; wherein the controlling of the first plurality of power switches comprises turning on a selected power switch and turning off one or more unselected power switches among the first plurality of power switches, and the turning off the one or more unselected power switches among the first plurality of power switches comprises applying a power supply voltage followed by a higher voltage from a charge pump to control gates of the one or more unselected power switches among the first plurality of power switches.

Example 22 includes the method of Example 21, wherein: the controlling of the second plurality of power switches comprises turning on a selected power switch and turning off one or more unselected power switches among the second plurality of power switches; and the turning off the one or more unselected power switches among the second plurality of power switches comprises applying a ground voltage followed by a lower, negative voltage from a charge pump to control gates of the one or more unselected power switches among the second plurality of power switches.

Example 23 includes a non-transitory machine-readable storage including machine-readable instructions that, when executed, cause a processor or other circuit or computing device to implement the method of Example 21 or 22.

Example 24 includes a computer program comprising instructions which, when the program is executed by a computer, cause the computer to carry out the method of Example 21 or 22.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus, comprising:
a power switch among a plurality of power switches which are coupled to a capacitor;
a driver coupled to a control gate of the power switch, wherein the driver has a power supply terminal and a ground terminal;
a first transistor coupled between the power supply terminal and a node;
a charge pump; and
a second transistor coupled between the control gate of the power switch and the charge pump.

2. The apparatus of claim 1, wherein the power switch is a first power switch, the charge pump is a first charge pump, and the apparatus further comprises:
a second power switch coupled to the capacitor;
a second charge pump; and
a third transistor coupled between a control gate of the second power switch and the second charge pump.

3. The apparatus of claim 1, wherein:
the capacitor is a charge transfer component in a switched capacitor voltage converter; and
the power switch is a p-type input power switch of the switched capacitor voltage converter or the power switch is an n-type output power switch of the switched capacitor voltage converter.

4. The apparatus of claim 1, wherein:
the capacitor is a charge transfer component in a switched capacitor voltage converter;
each power switch of the plurality of power switches is coupled between a respective voltage rail and the capacitor; and
each respective voltage rail is to provide a voltage at a different level.

5. The apparatus of claim 1, further comprising a third transistor coupled between the ground terminal and a ground node, wherein the third transistor is to turn on to couple the ground terminal to the ground node.

6. The apparatus of claim 1, wherein:
the driver is to apply a turn off voltage to the control gate of the power switch while another power switch of the plurality of power switches is turned on; and
during the applying of the turn off voltage to the control gate of the power switch, the first transistor is to receive a control gate voltage to turn off and block the power supply terminal from the node and the second transistor is to receive a control gate voltage to turn on to couple the control gate of the power switch to the charge pump.

7. The apparatus of claim 1, wherein a turn off of the first transistor and a turn on of the second transistor are started after a start of the driver applying a turn off voltage to the power switch.

8. The apparatus of claim 1, wherein the node is a ground node and when the second transistor is turned on, the charge pump is to decrease a voltage of the control gate of the power switch from a voltage of the ground node to a voltage which is output by the charge pump.

9. The apparatus of claim 1, wherein the node is a power supply node and when the second transistor is turned on, the charge pump is to increase a voltage of the control gate of the power switch from a voltage of the power supply node to a voltage which is output by the charge pump.

10. The apparatus of claim 9, wherein the voltage which is output by the charge pump provides a greater leakage protection for the power switch compared to the voltage of the power supply node.

11. The apparatus of claim 1, further comprising a switched capacitor voltage converter which includes the plurality of power switches, the capacitor, the driver, the first transistor, the charge pump and the second transistor, wherein the switched capacitor voltage converter is provided in at least one of an integrated circuit, a System on Chip, a System in Package or a computing device.

12. An apparatus, comprising:
a first transistor in series with a second transistor, wherein the first transistor is coupled to a power supply node;
a power switch having a control gate coupled to a node between the first transistor and the second transistor;
a bootstrap capacitor coupled to the control gate of the power switch, wherein the bootstrap capacitor is to receive a clock signal;
a logic circuit coupled to a control gate of the first transistor; and
a driver coupled to the logic circuit and to a control gate of the second transistor.

13. The apparatus of claim 12, wherein:
the power switch comprises a p-type transistor;
in response to a transition in an output of the driver, the logic circuit is to turn on the first transistor to increase a voltage of the control gate of the power switch to a voltage of the power supply node; and
the clock signal is to decrease and then increase, to increase the voltage of the control gate of the power switch higher than the voltage of the power supply node based on a voltage across the bootstrap capacitor.

14. The apparatus of claim 13, wherein:
the logic circuit is to turn on the first transistor for a first time period; and
the decrease and increase of the clock is in a second time period which starts after a start of the first time period and ends after an end of the first time period.

15. The apparatus of claim 13, wherein the turn on of the first transistor and the decrease and then increase of the clock occur multiple times after a single transition of the output of the driver.

16. An apparatus, comprising:
a memory to store instructions; and
a control circuit to execute the instructions to:
apply a control gate voltage at a turn on level to one selected power switch at a time among a first plurality of power switches to couple a respective voltage rail of the selected power switch to a capacitor in a switched capacitor voltage converter, wherein each power switch of the first plurality of power switches is coupled between the respective voltage rail and to the capacitor; and
apply control gates voltages at a first turn off level and then at a second turn off level to unselected power switches of the first plurality of power switches during the applying of the control gate voltage at the turn on level to the one selected power switch, wherein when the unselected power switches comprise n-type transistors, the first turn off level is less than the second turn off level, and when the unselected power switches comprise p-type transistors, the first turn off level is greater than the second turn off level.

17. The apparatus of claim 16, wherein:
the first plurality of power switches are in a power switch circuit;
when a load current of the switched capacitor voltage converter is below a lower threshold, the control circuit is to execute the instructions to turn off, and park in an anti-leakage mode, a portion of all power switches in the power switch circuit; and
when the load current is above an upper threshold, the control circuit is to execute the instructions to turn on all of the power switches of the power switch circuit.

18. The apparatus of claim 16, wherein:
each power switch of the first plurality of power switches comprises a respective driver coupled to a control gate of the power switch;
the respective driver comprises a power supply terminal coupled to a power supply node;
the control gate of the power switch is coupled to a respective charge pump; and
the first turn off level is based on a level of the power supply node and the second turn off level is based on a level of the respective charge pump, which is greater than the level of the power supply node.

19. The apparatus of claim 16, wherein:
each power switch of the first plurality of power switches comprises a respective driver coupled to a control gate of the power switch;
the respective driver comprises a ground terminal coupled to a ground node;
the control gate of the power switch is coupled to a respective charge pump; and
the first turn off level is based on a level of the ground node and the second turn off level is based on a level of the respective charge pump, which is less than the level of the ground node.

20. The apparatus of claim 16, wherein the first plurality of power switches are coupled to a first side of the capacitor and the control circuit is to execute the instructions to:
apply a control gate voltage at a turn on level to one selected power switch at a time among a second plurality of power switches to couple a respective voltage rail of the selected power switch among the second plurality of power switches to a second side of the capacitor, wherein each power switch of the second plurality of power switches is coupled between an output node and the second side of the capacitor.
